(19) United States
(12) Patent Application Publication
(10) Pub. No.: US 2015/0329728 A1
(43) Pub. Date: Nov. 19, 2015

(54) AMINE COMPOUNDS AND THEIR USE AS ZERO OR LOW VOC NEUTRALIZERS

(71) Applicant: ANGUS CHEMICAL COMPANY, Buffalo Grove, IL (US)

(72) Inventors: William C. Miles, Buffalo Grove, IL (US); Charles E. Coburn, Vernon Hills, IL (US)

(73) Assignee: ANGUS Chemical Company, Buffalo Grove, IL (US)

(21) Appl. No.: 14/653,115

(22) PCT Filed: Nov. 19, 2013
(86) PCT No.: PCT/US2013/070690

§ 371 Date: Jun. 17, 2015

Related U.S. Application Data
(60) Provisional application No. 61/738,581, filed on Dec. 18, 2012.

(51) Int. Cl. C09D 7/12; C10M 135/10; C11D 3/36; C10M 133/12; C11D 3/33; C11D 3/34; C10M 133/06; C10M 137/12

(52) U.S. Cl. CPC C09D 7/1233; C10M 133/06; C10M 135/10; C10M 137/12; C10M 133/12; C11D 3/33; C11D 3/349; C11D 3/364; C10M 2215/04; C10M 2215/06; C10M 2219/044; C10M 2223/061

(57) ABSTRACT

Provided are compounds for use as neutralizing agents in aqueous formulations. The compounds are of the formula I: [Formula should be inserted here] wherein R, R′, X, and M⁺ are as described herein.

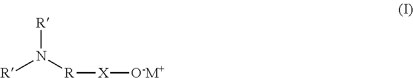

### CROSS-REFERENCE TO RELATED APPLICATIONS

This application claims priority from provisional application Ser. No. 61/738,581, filed Dec. 18, 2012, which is incorporated herein by reference in its entirety.

### FIELD

This invention relates generally to amine compounds and their use as zero or low volatile organic content (VOC) neutralizer additives for various applications, such as cleaning products and paints and coatings.

### BACKGROUND

Organic amines are used in many applications as neutralizing agents. In a number of geographies, manufacturers are facing regulations to reduce the volatile organic content (VOC) of their formulations. Most conventional organic neutralizing amines are 100% volatile and are therefore VOC contributors.

Ammonia and inorganic hydroxides and carbonates are potential alternatives for use as neutralizers, that are by definition non-VOC contributors. However, ammonia, while an efficient neutralizer, has a very strong odor and is therefore unsuitable for use in applications requiring low odor, such as low odor paint. Inorganic hydroxides and carbonates are undesirable in some applications such as paints and coatings because they often result in coatings with poor scrub resistance.

The problem addressed by this invention is the provision of new low or no VOC neutralizing agents.

### STATEMENT OF INVENTION

We have now discovered that compounds as described herein function as efficient neutralizers for aqueous formulations. Advantageously the compounds exhibit either low or no VOC and in some embodiments, may exhibit very low amine odor.

In one aspect, there is provided a method for neutralizing an aqueous formulation identified as in need of neutralization, the method comprising using, as a neutralizing agent in the formulation, a compound of formula I:

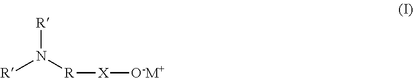

wherein R is linear or branched C₁-C₁₄ alkylene, C₅-C₈ cycloalkylene, C₁-C₁₄ alkylene substituted with aryl, or arylene, wherein each alkylene, cycloalkylene, aryl, and arylene of the R group is optionally substituted with 1 to 2 groups independently selected from OH, COOH, COOM⁺, C₁-C₆ alkoxy, halide, ester, amine, and amide;

R′ at each occurrence is independently H or linear or branched C₁-C₄ alkyl;

X is CO, SO, SO₂, POH, PO-M⁺, P(═O)OH, or P(═O)O⁻M⁺; and

M⁺ at each occurrence is independently a mono valent (Group 1A) or di valent (Group 2A) metal cation, an amine-based cation or mixtures thereof.

In another aspect, there is provided an aqueous based paint or coating comprising a neutralizing agent, a binder, a carrier, and optionally a pigment, wherein the neutralizing agent is a compound of formula I as described herein.

In a further aspect, there is provided a cleaning formulation comprising a neutralizing agent, a surfactant, and water, wherein the neutralizing agent is a compound of formula I as described herein.

### DETAILED DESCRIPTION

Unless otherwise indicated, numeric ranges, for instance as in “from 2 to 10,” are inclusive of the numbers defining the range (e.g., 2 and 10).

Unless otherwise indicated, ratios, percentages, parts, and the like are by weight.

“Alkyl,” as used in this specification, whether alone or as part of another group (e.g., in arylalkyl), encompasses straight and branched chain aliphatic groups having the indicated number of carbon atoms. If no number is indicated, then 1-6 alkyl carbons are contemplated. Preferred alkyl groups include, without limitation, methyl, ethyl, propyl, isopropyl, butyl, isobutyl, sec-butyl, tert-butyl, pentyl, and hexyl.

The term “cycloalkyl” refers to saturated and partially unsaturated cyclic hydrocarbon groups having the indicated number of ring carbon atoms. Preferred cycloalkyl groups include, without limitation, cyclopropyl, cyclobutyl, cyclopentyl, cyclohexyl, cycloheptyl, and cyclooctyl. The cycloalkyl is optionally substituted with linear or branched C₁-C₆ alkyl, in addition to any other optional substituents described herein.

An “aryl” group is a C6-C14 aromatic moiety comprising one to three aromatic rings. Preferably, the aryl group is a C6-C12 aryl group. Suitable aryl include, without limitation, phenyl, naphthyl, anthracenyl, and fluorenyl. Preferred are phenyl and naphthyl.

The terms “alkylene,” “cycloalkylene,” and “arylene” correspond to the groups defined above but that are positioned between and serve to connect two other chemical groups. By way of example, alkylene groups include, without limitation, methylene, ethylene, propylene, and butylene. Arylene groups include, again without limitation, phenylene.

As noted above, the invention provides methods and formulations containing compounds that are useful as neutralizing agents. Neutralizing agents may be included in various formulations to, for example, neutralize residual acid moieties or to raise the pH to a desired value, sometimes between about 8 and 10. Most conventional neutralizing agents currently used in many industries, including paints and coatings and cleaners, are VOC contributors. In addition, when used in an otherwise low VOC formulation, the odor of conventional neutralizing agents is more noticeable.

In contrast, the compounds of the invention are zero or very low VOC materials that may also exhibit low odor. In addition, the compounds may impart comparable performance properties to those provided by conventional neutralizing compounds. Consequently, the advantage of low VOC may be achieved with the compounds of the invention, without significant negative impact on other attributes of aqueous formulations in which they are used. Thus, low or zero VOC formulations containing neutralizing agents may be provided by this invention.

The neutralizing agents used in the invention are compounds of the formula I:

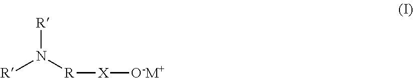

wherein R, R′, X, and M⁺ are as described herein.

In some embodiments, compounds of formula I are of the formula I-1, which are compounds of formula I in which X is CO.

In some embodiments, compounds of formula I are of the formula I-2, which are compounds of formula I in which X is SO₂.

In some embodiments, compounds of formula I are of the formula I-3, which are compounds of formula I in which X is SO.

In some embodiments, compounds of formula I are of the formula I-4, which are compounds of formula I in which X is P(═O)OH, or P(═O)O⁻M⁺.

In some embodiments, compounds of formula I are of the formula I-5, which are compounds of formula I in which X is POH or PO-M⁺.

In some embodiments, compounds of formulae I, I-1, I-2, I-3, I-4, and I-5 are of the formula I-6, which are compounds of formula I, I-1, I-2, I-3, I-4, or I-5 wherein R is linear or branched C₁-C₁₄ alkylene, C₅-C₈ cycloalkylene, or arylene (preferably phenylene), wherein alkylene, cycloalkylene, and arylene are optionally substituted with 1 to 2 groups independently selected from OH, COOH, COOM⁺, C₁-C₆ alkoxy, alkyl, halide, ester, amine, and amide. In some embodiments, R is linear or branched C₁-C₁₄ alkylene or C₅-C₈ cycloalkylene, wherein alkylene and cycloalkylene are optionally substituted with COOH or COOM⁺. In some embodiments, R is linear or branched C₁-C₇ alkylene optionally substituted with COOH or COOM⁺. In some embodiments, R is C₁-C₄ alkylene.

In some embodiments, compounds of formulae I, I-1, I-2, I-3, I-4, and I-5 are of the formula 1-7, which are compounds of formula I, I-1, I-2, I-3, I-4, or I-5 wherein R is arylene optionally substituted with alkyl or OH. In some embodiments, R is phenylene or naphthylene optionally substituted with alkyl or OH. In some embodiments, R is phenylene optionally substituted with alkyl or OH.

In some embodiments, compounds of formulae I, I-1, I-2, I-3, I-4, I-5, I-6, and I-7 are of the formula I-8, which are compounds of formula I, I-1, I-2, I-3, I-4, I-5, I-6, or I-7 wherein R′ at each occurrence is independently H or methyl. In some embodiments, R′ at each occurrence is H.

In some embodiments, compounds of formulae I, I-1, I-2, I-3, I-4, I-5, I-6, I-7, and I-8 are of the formula 1-9, which are compounds of formula I, I-1, I-2, I-3, I-4, I-5, I-6, I-7, or I-8 wherein M⁺ is sodium ion, potassium ion, magnesium ion, calcium ion (e.g., two compounds of formula I may use Ca2+ as the counterion), or choline ion. In some embodiments, M⁺ is sodium ion.

In some embodiments, compounds of formulae I, I-6, I-7, I-8, and I-9 are of the formula I-10, which are compounds of formula I, I-6, I-7, I-8, or I-9 wherein X is CO, SO, or SO₂.

In some embodiments, the compound of formula I is: 2-aminoisobutyric acid sodium salt, 2-aminopropionic acid sodium salt, aminoacetic acid sodium salt, 4-aminobutyric acid sodium salt, 6-aminohexanoic acid sodium salt, 8-aminooctanoic acid sodium salt, 4-aminobenzoic acid sodium salt, 3-aminobutanoic acid sodium salt, L-2-aminobutyric acid sodium salt, 4-aminosalicylic acid sodium salt, aspartic acid sodium salt, glutamic acid sodium salt, taurine sodium salt, sulfanilic acid sodium salt, (aminomethyl)phosphonic acid sodium salt, alpha amino benzeneacetic acid sodium salt, 4-dimethylamino-meta-tolylphosphinic acid sodium salt, or a mixture of two or more thereof.

A preferred compound of formula I is 2-aminoisobutyric acid sodium salt.

The compounds of formula I may be readily prepared by literature methods. For example, a starting amino acid may be purchased or synthesized. The acid may be mixed with a based containing the desired cation (M⁺). For instance, if the sodium salt is desired, than sodium hydroxide may be used. Examples of other bases include calcium hydroxide and choline hydroxide.

The compounds of formula I are useful as neutralizing agents in aqueous formulations. The compounds exhibit low or no VOC and as a result, formulations that are overall low or no VOC may be prepared. In some embodiments, the compounds of the invention or the formulations in which they are included exhibit a vapor pressure for the organic (non-aqueous) components at 20° C. of less than 0.2 mm Hg, alternatively less than 0.1 mm Hg. In some embodiments, all organic (non-aqueous) components in a formulation of the invention, including the compounds of formula I, exhibit a boiling point of above 180° C., alternatively above 200° C., or alternatively above 216° C.

Examples of formulations in which the compounds of formula I may be included as neutralizers include, without limitation, cleaning products (household or industrial), metalworking fluids, and paint and coatings.

In a preferred embodiment, the aqueous formulation is a paint or coating. The paint or coating is used to provide a protective and/or decorative barrier for residential and industrial surfaces, such as for floors, automobiles, exteriors and interiors of houses, and other buildings. The paint or coating formulation, in addition to comprising a neutralizing agent, may also comprise a binder, a carrier, and optionally a pigment.

Pigments may be included to provide hiding power and the desired color to the final coated material and may also be used to provide bulk to the paint or coating. While multiple pigments may be present in end-use paints or coatings, sometimes only white pigment, such as titanium oxide, perhaps in combination with extender pigments such as calcium carbonate and/or kaolin clay, is added in the early stages of the formation of the formulation. Any other desired pigments of various colors (including more white pigment) can optionally be added at the later stages of, or after, the formulation is completed.

Pigments may be organic or inorganic. Examples of pigments can include, but are not limited to, titanium dioxide, kaolin clay, calcined kaolin clay, carbon black, iron oxide black, iron oxide yellow, iron oxide red, iron oxide brown, organic red pigments, including quinacridone red and metallized and non-metallized azo reds (e.g., lithols, lithol rubine, toluidine red, naphthol red), phthalocyanine blue, phthalocyanine green, mono- or di-arylide yellow, benzimidazolone yellow, heterocyclic yellow, quinacridone magenta, quinacridone violet, and the like, and any combination thereof.

Binders are included in paint and coating formulations to provide a network in which the pigment particles are dispersed and suspended. Binders bind the pigment particles together and provide integrity and adhesion for the paint or coating film. Generally, for aqueous based paints and coatings, the binders are latex based materials.

Latex binders are typically prepared by free radical initiated aqueous emulsion polymerization of a monomer mixture containing alkyl acrylate (methyl acrylate, ethyl acrylate, butyl acrylate and/or 2-ethylhexylacrylate), alkyl methacrylate, vinyl alcohol/acetate, styrene, and/or acrylonitrile and ethylene type monomers. Suitable binders include acrylic, vinyl acrylic, styrenated-acrylic, vinyl acetate ethylene based materials, or blends of these materials. The amount of the binder in the formulations of the invention can be the amount conventionally used in paint and coating formulations, which can vary widely due to the desired gloss/sheen range, and also the solids concentration, of a specific paint formulation. By way of non-limiting example, the amount of binder solids can be from about 5% to about 30% of the total formula volume.

A paint and coating formulation also contains a carrier in which the formulation ingredients are dissolved, dispersed, and/or suspended. In the aqueous based formulations contemplated by the invention, the carrier is usually water, although other water-based solutions such as water-alcohol mixtures and the like may be used. The aqueous carrier generally makes up the balance of the formulation, after all the other ingredients have been accounted for.

Other additives may be included in the paint and coating formulations besides the neutralizing agents, pigments, binders, and carriers discussed above. These include, but are not limited to, leveling agents and surfactants, thickeners, rheology modifiers, co-solvents such as glycols, including propylene glycol or ethylene glycol, corrosion inhibitors, defoamers, co-dispersants, additional aminoalcohol compounds, and biocides.

The paint and coating formulations may be manufactured by conventional paint manufacturing techniques, which are well known to those skilled in the art. Typically, the formulations are manufactured by a two-step process. First, a dispersion phase, commonly referred to as the grind phase, is prepared by mixing the dry pigments with other grind phase components, including most other solid powder formulation materials, under constant high shear agitation to provide a high viscosity and high solids mixture. This part of the process is designed to effectively wet and dis-agglomerate the dry pigments and stabilize them in an aqueous dispersion.

The second step of the paint manufacturing process is commonly referred to as the letdown or thindown phase, because the viscous grind is diluted with the remaining formulation components, which are generally less viscous than the grind mix. Typically, the binders, any predispersed pigments, and any other paint materials that only require mixing and perhaps moderate shear, are incorporated during the letdown phase. The letdown phase may be done either by sequentially adding the letdown components into a vessel containing the grind mix, or by adding the grind mix into a vessel containing a premix of the latex resins and other letdown components, followed by sequential addition of the final letdown components. In either case, constant agitation is needed, although application of high shear is not required.

Cleaning formulations according to the invention may comprise a neutralizing agent, a surfactant, water, and an optional solvent, wherein the neutralizing agent is a compound of formula I. The surfactant may be selected from one or more of nonionic, anionic, cationic, ampholytic, amphoteric and zwitterionic surfactants. A typical listing of anionic, ampholytic, and zwitterionic classes, and species of these surfactants, is given in U.S. Pat. No. 3,929,678. A list of suitable cationic surfactants is given in U.S. Pat. No. 4,259,217. Each of these documents is incorporated herein by reference. The surfactants may typically be present at a level of from 0.1 to 15, alternatively from 0.1 to 10, or alternatively from 0.1 to 5.0 percent by weight, based on the total weight of the formulation.

Water is generally the dominant component of the aqueous cleaning formulation and may typically comprises at least 50, more typically at least 80 and even more typically at least 90, weight percent based on the total weight of the formulation. The water is typically present at a level of less than 99.5%, more typically less than 99% and even more typically less than 98%. Deionized water is preferred. If the cleaning composition is concentrated, then the water may be present in the composition at a concentration of less than 85 wt. %.

Optional solvents for use in the cleaning formulation may include, for instance, any water miscible solvent, such as ethylene oxide based or propylene oxide based glycol ethers, sugar alcohols, polyols, fatty acid methyl esters, etc. Solvents that are low VOC and in particular exhibit a vapor pressure of lower than 0.1 mm Hg at 20° C. are preferred and may include, for instance, glycol ether solvents such as propyleneglycol n-butyl ether, propyleneglycol n-propyl ether, dipropyleneglycol methyl ether, dipropyleneglycol propyl ether, dipropyleneglycol n-butyl ether, tripropyleneglycol n-butyl, and tripropyleneglycol methyl ether. When used, the optional solvent may typically be present in the formulation in an amount ranging from 0.1 to 10 weight percent, alternatively 0.1 to 5.0 weight percent, or alternatively from 0.5 to 2.0 weight percent, based on the total weight of the formulation.

Other additives known for use in cleaning formulations may be included such as, without limitation, alkaline agents, builders, fragrances, preservatives, biocides, colorants, dyes and rheology modifiers. These optional additives are used in known quantities and in known ways.

The compounds of formula I of the invention are typically added to an aqueous formulation at one or more steps during the formulation manufacturing process. For instance, when the formulation is a paint or coating, the compound may be added at one or more of three different places: to the pigment dispersion, to the binder dispersion, and/or in a final addition to the paint formulation.

The amount of compound of formula I used may typically be determined based on the desired pH of the formulation. Typically, an amount of the compound is added so as to provide a final pH in the range of about 7 to 11, alternatively about 8 to 10, or alternatively about 8.5 to 9.5. In some embodiments, inorganic bases, such as sodium hydroxide, may also be used, together with the compounds of formula I, to further facilitate the neutralization properties.

In a further aspect, the invention provides a method for reducing the volatile organic compound content of an aqueous formulation that contains a neutralizing agent. The method comprises using as the neutralizing agent an effective amount of a compound of formula I. As noted above, an effective amount is typically the quantity required to provide a pH of about 7 to 11, alternatively about 8 to 10, or alternatively about 8.5 to 9.5, in the formulation.

As noted above, the compounds of the invention function as zero or low VOC and low odor neutralizers for aqueous formulations. Some embodiments of the invention will now be described in detail in the following Examples.

### EXAMPLES

### Example 1

### Preparation of 2-aminoisobutyric acid sodium salt (Na-AIBA)

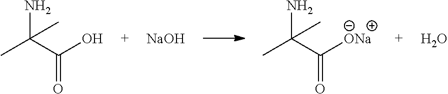

Commercially available 2-aminoisobutyric acid is purchased and mixed on a mole to mole basis with sodium hydroxide to yield a mole of the 2-aminoisobutyric acid sodium salt and water.

### Example 2

### 2-aminoisobutyric acid sodium salt (Na-AIBA) VOC Characteristics

Zero VOC can be defined in one of three ways according to California Air Resources Board (CARB) Method 310 for VOC determination: the vapor pressure can be below 0.1 mm Hg at 20° C., the boiling point can be above 216° C., or the compound must pass a gas chromatograph test (EPA Method 18, 8240B, 8260B, ASTM D859-000, or NIOSH method 1400).

The Na-AIBA of the example has no discernable vapor pressure. Also, the material does not elute on the GC because it cannot be vaporized. This is in contrast to the non-neutralized amino acid that fragments when tested on the GC. Thus, the Na-AIBA of Example 1 can be classified as a zero VOC under CARB Method 310.

Upon inclusion into a paint formulation, slightly more (17%) of this molecule is needed to regulate pH than a control compound (2-amino-2-methyl-l-propanol (AMP)) with a measured neutralization equivalent of 89. Thus, the compound is an effective neutralizer.

### Example 3

### 2-Aminopropionic Acid Sodium Salt

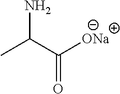

The title compound may be prepared through substantially the same procedure as described in Example 1, using alanine as the starting amino acid.

### Example 4

### Aminoacetic Acid Sodium Salt

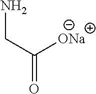

The title compound may be prepared through substantially the same procedure as described in Example 1, using glycine as the starting amino acid.

### Example 5

### 4-Aminobutyric Acid Sodium Salt

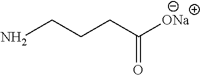

The title compound may be prepared through substantially the same procedure as described in Example 1, using aminobutyric acid as the starting amino acid.

### Example 6

### 6-Aminohexanoic Acid Sodium Salt

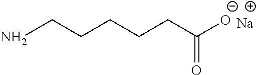

The title compound may be prepared through substantially the same procedure as described in Example 1, using aminohexanoic acid as the starting amino acid.

### Example 7

### 8-Aminooctanoic Acid Sodium Salt

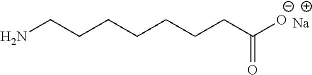 [SMILES: NCCCCCCCC(=O)[O-] ; [Na+]]

The title compound may be prepared through substantially the same procedure as described in Example 1, using aminooctanoic acid as the starting amino acid.

### Example 8

### 4-Aminobenzoic Acid Sodium Salt

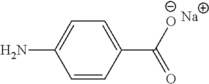

The title compound may be prepared through substantially the same procedure as described in Example 1, using aminobenzoic acid as the starting amino acid.

### Example 9

### 3-Aminobutanoic Acid Sodium Salt

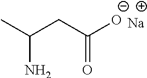

The title compound may be prepared through substantially the same procedure as described in Example 1, using 3-aminobutanoic acid as the starting amino acid.

### Example 10

### L-2-Aminobutyric Acid Sodium Salt

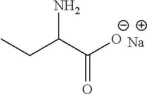

The title compound may be prepared through substantially the same procedure as described in Example 1, using L-2-aminobutyric acid as the starting amino acid.

### Example 11

### 4-Aminosalicylic Acid Sodium Salt

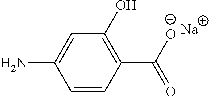 [SMILES: Nc1ccc(C(=O)[O-])c(O)c1 ; [Na+]]

The title compound may be prepared through substantially the same procedure as described in Example 1, using aminosalicylic acid as the starting amino acid.

### Example 12

### Aspartic Acid Sodium Salt

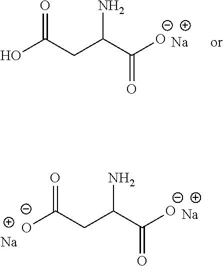

The title compound may be prepared through substantially the same procedure as described in Example 1, using aspartic acid as the starting amino acid.

### Example 13

### Glutamic Acid Sodium Salt

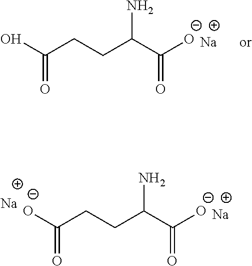 [SMILES: NC(CCC(=O)O)C(=O)[O-] ; [Na+] ; [Na+] ; NC(CCC(=O)[O-])C(=O)[O-] ; [Na+]]

The title compound may be prepared through substantially the same procedure as described in Example 1, using glutamic acid as the starting amino acid.

### Example 14

### Taurine Sodium Salt

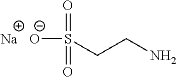

The title compound may be prepared through substantially the same procedure as described in Example 1, using taurine as the starting amino acid.

### Example 15

### Sulfanilic Acid Sodium Salt

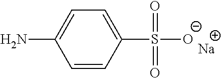 [SMILES: Nc1ccc(S(=O)(=O)[O-])cc1 ; [Na+]]

The title compound may be prepared through substantially the same procedure as described in Example 1, using sulfanilic acid as the starting amino acid.

### Example 16

### (Aminomethyl)phosphonic Acid Sodium Salt

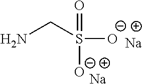

The title compound may be prepared through substantially the same procedure as described in Example 1, using (aminomethyl)phosphonic acid as the starting amino acid.

### Example 17

### Alpha Amino Benzeneacetic Acid Sodium Salt

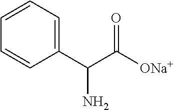

The title compound may be prepared through substantially the same procedure as described in Example 1, using alpha amino benzeneacetic acid as the starting amino acid.

### Example 18

### 4-Dimethylamino-meta-tolylphosphinic Acid Sodium Salt

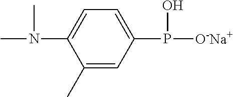

The title compound may be prepared through substantially the same procedure as described in Example 1, using 4-dimethylamino-meta-tolylphosphinic acid as the starting amino acid. The material may also be commercially available.

### Example 19

### VOC Testing

The VOC of various representative example compounds is tested using gas chromatograph, as follows:

Gas Chromatograph: HP 5890 Series II

Column: J&W DB-5 30 m*0.25 mm*1.0 μm

Detector: FID at 280° C.

Temperature: Injector: 250° C.

Oven: 50° C. for 4 minutes, ramp at 20° C./min to 250° C., hold 10 min.

Injection: 1 μL with split ratio: 50:1

Carrier Gas: Helium

VOC is tested using a modified version of ASTM D6886-12 (Standard Test Method for Determination of the Individual Volatile Organic Compounds (VOCs) in Air-Dry Coatings by Gas Chromatography). The actual method involves GC analysis of a paint sample. For the modified test used in the present examples, GC analysis is conducted directly on a 5 wt % aqueous solution of the subject compound, and not a paint sample containing the compound. The salts selected as “pass” show very small GC peaks, if any, compared to their corresponding free amine peaks, indicating that these materials will likely give peaks below the 50 ppm threshold if used in a paint. Data are shown in Table 1.

TABLE 1

| Compound (Ex. No.) | VOC Test |
|---|---|
| 2-Aminoisobutyric acid sodium salt (Ex. 1) | pass |
| Aminoacetic acid sodium salt (Ex. 4) | pass |
| 8-Aminooctanoic acid sodium salt (Ex. 7) | pass |
| 4-Aminobenzoic acid sodium salt (Ex. 8) | Nearly passes, |
| | 99.6% reduction |
| | in signal |
| Aspartic acid sodium salt (Ex. 12) | pass |
| Taurine sodium salt (Ex. 14) | pass |
| Sulfanilic acid sodium salt (Ex. 15) | pass |
| (Aminomethyl)phosphonic acid sodium salt (Ex. 16) | pass |
| Alpha amino benzeneacetic acid sodium salt (Ex. 17) | fail |
| 4-Dimethylamino-meta-tolylphosphinic acid sodium | fail |
| salt (Ex. 18) | |

Two amines, amino-2-methyl-1-propanol (AMP) and choline hydroxide, are tested for neutralization of AIBA (2-aminoisobutyric acid) and both times there are multiple peaks in the GC. Hence the amine salts of amino acids go through the GC and would likely not be classified as non-VOC.

1. A method for neutralizing an aqueous formulation identified as in need of neutralization, the method comprising using, as a neutralizing agent in the formulation, a compound of formula I: 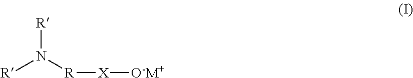
wherein R is linear or branched C₁-C₁₄ alkylene, C₅-C₈ cycloalkylene, C₁-C₁₄ alkylene substituted with aryl, or arylene, wherein each alkylene, cycloalkylene, aryl, and arylene is optionally substituted with 1 to 2 groups independently selected from OH, COOH, COOM⁺, C₁-C₆ alkoxy, alkyl, halide, ester, amine, and amide;
R′ at each occurrence is independently H or linear or branched C₁-C₄ alkyl;
X is CO, SO, SO₂, POH, PO-M⁺, P(═O)OH, or P(═O)O⁻M⁺; and
M at each occurrence is independently a mono valent (Group 1A) or di valent (Group 2A) metal cation, an amine-based cation or mixtures thereof.

2. An aqueous formulation comprising a neutralizing agent, wherein the aqueous formulation is an aqueous based paint or coating, a metalworking fluid, or a cleaning product wherein
the aqueous based paint or coating further comprises a binder, a carrier, and an optional pigment,
the cleaning product further comprises a surfactant and water, and
the neutralizing agent is a compound of formula I: 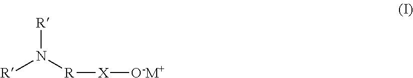
wherein R is linear or branched C₁-C₁₄ alkylene, C₅-C₈ cycloalkylene, C₁-C₁₄ alkylene substituted with aryl, or arylene, wherein each alkylene, cycloalkylene, aryl, and arylene is optionally substituted with 1 to 2 groups independently selected from OH, COOH, COOM⁺, C₁-C₆ alkoxy, alkyl, halide, ester, amine, and amide;
R′ at each occurrence is independently H or linear or branched C₁-C₄ alkyl;
X is CO, SO, SO₂, POH, PO-M⁺, P(═O)OH, or P(═O)O⁻M⁺; and
M⁺ at each occurrence is independently a mono valent (Group 1A) or di valent (Group 2A) metal cation, an amine-based cation or mixtures thereof.

3.-4. (canceled)

5. The method of claim 1 wherein X is CO or SO₂.

6. The method of claim 1 wherein R is linear or branched C₁-C₁₄ alkylene, C₅-C₈ cycloalkylene, or arylene, wherein alkylene, cycloalkylene, and arylene are optionally substituted with 1 to 2 groups independently selected from OH, COOH, COOM⁺, C₁-C₆ alkoxy, alkyl, halide, ester, amine, and amide.

7. The method of claim 1 wherein R is linear or branched C₁-C₇ alkylene optionally substituted with COOH or COOM⁺.

8. The method of claim 1 wherein R′ at each occurrence is independently H or methyl.

9. The method of claim 1 wherein M⁺ at each occurrence is a mono valent or divalent cation.

10. (canceled)

11. The method of claim 1 wherein R is linear or branched C₁-C₁₄ alkylene or C₅-C₈ cycloalkylene, wherein alkylene and cycloalkylene are optionally substituted with COOH or COOM⁺.

12. The method of claim 1 wherein R is linear or branched C₁-C₄ alkylene.

13. The method of claim 1 wherein R is arylene optionally substituted with alkyl or OH.

14. The method of claim 1 wherein R is phenylene or naphthylene optionally substituted with alkyl or OH.

15. The method of claim 1 wherein R′ at each occurrence is H.

16. The method of claim 1 wherein M⁺ at each occurrence is sodium ion, potassium ion, magnesium ion, calcium ion, or choline ion.

17. The method of claim 1 wherein the compound of formula I is 2-aminoisobutyric acid sodium salt, 2-aminopropionic acid sodium salt, aminoacetic acid sodium salt, 4-aminobutyric acid sodium salt, 6-aminohexanoic acid sodium salt, 8-aminooctanoic acid sodium salt, 4-aminobenzoic acid sodium salt, 3-aminobutanoic acid sodium salt, L-2-aminobutyric acid sodium salt, 4-aminosalicylic acid sodium salt, aspartic acid sodium salt, glutamic acid sodium salt, taurine sodium salt, sulfanilic acid sodium salt, (aminomethyl)phosphonic acid sodium salt, alpha amino benzeneacetic acid sodium salt, 4-dimethylamino-meta-tolylphosphinic acid sodium salt, or mixtures thereof.

18. The method of claim 1 wherein the compound of formula I is a low or no VOC compound.

19. The method of claim 1 wherein the formulation is an aqueous based paint or coating, a metalworking fluid, or a cleaning product.

20. The method of claim 1 wherein the formulation is an aqueous based paint or coating formulation comprising a neutralizing agent, a binder, a carrier, and an optional pigment, wherein the neutralizing agent is a compound of formula I.

21. The method of claim 20 wherein the aqueous based paint or coating formulation has a pH of about 7 to 11.

22. The method of claim 1 wherein the formulation is a cleaning formulation comprising a neutralizing agent, a surfactant, and water, wherein the neutralizing agent is a compound of formula I.

23. The method of claim 22 wherein the surfactant comprises about 0.1 wt % to about 15 wt % of the total cleaning formulation.
